(19) United States
(12) Patent Application Publication
(10) Pub. No.: US 2003/0055089 A1
(43) Pub. Date: Mar. 20, 2003

(54) ENDOPARASITICIDAL AND ECTOPARASITICIDAL AGENTS

(76) Inventors: KIRKOR SIRINYAN, GLADBACH (DE); HUBERT DORN, WUPPERTAL (DE); KIRSTEN HEESCHEN, KONIGSWINTER (DE); ULRICH HEUKAMP, KURTEN (DE); RICHARD KUJANEK, KOLN (DE)

Correspondence Address: BAYER CORPORATION, PATENT DEPARTMENT, 100 BAYER ROAD, PITTSBURGH, PA, 152059741

(21) Appl. No.: 09/331,040

(22) PCT Filed: Dec. 11, 1997
(86) PCT No.: PCT/EP97/06926

(30) Foreign Application Priority Data
Dec. 23, 1996 (DE) 196 54 079.8

(51) Int. Cl. A01N 43/40; A01N 43/04; A01N 43/42; A01N 25/00; A01N 25/32; A01N 43/02

(52) U.S. Cl. 514/341; 514/450; 514/30; 424/405; 424/406

(57) ABSTRACT

The present invention relates to mixtures of avermectins, 22,23-dihydroavermectin B₁ (ivermectin) and milbemycins from the class of the macrocyclic lactones with agonists or antagonists of the nicotinergic acetylcholine receptors of insects, if appropriate in the presence of other active compounds and diluents or excipients.

The present invention relates to mixtures of avermectins, 22,23-dihydroavermectins B₁ (ivermectins) and milbemycins from the class of the macrocyclic lactones with agonists or antagonists of the nicotinergic acetylcholine receptors of insects for controlling ecto- and endoparasites.

Gastrointestinal nematode infections of dogs are in most cases brought about by species of the three nematode families Ascarididae, Ancylostomatidae and Trichuridae. In cats, it is predominantly the two nematode families Ascarididae and Ancylostomatidae which occur worldwide. After passing through a number of development stages in a very great diversity of tissues of the host animals, patent infection of the gastrointestinal tract occurs. During the prepatency and patency of the infection, the parasitosis of round worms, hook worms and whip worms causes considerable problems, especially in young, growing dogs, cats and also in humans. Therapy or prophylactic treatment is therefore in urgent necessity in order both to cure animals already affected and to maintain as yet unaffected animals in a healthy condition.

Consequently, the protection of dogs and cats against infection is of very great importance as prophylaxis against infections of humans, in particular of children.

Particular mention must be made of the parasite Dirofilaria immitis—a Filaria endemic in parts of North to South America, Africa, Asia and also Australia. This parasite is the cause of the important canine and feline cadiovascular dirofilariosis. The severe pathophysiological changes within the cardiovascular system which occur during the Dirofilaria immitis infection of dogs and cats can bring about a dramatic course of the disease in the host animal.

The anthelmintics ivermectin/milbemycin from the class of the macrocyclic lactones show activity against Dirofilaria immitis in dogs and cats. These active compounds are usually administered orally or parenterally.

Flea infestations of pets such as dogs and cats are not only a nuisance for the infected animals, but they also cause considerable pain (sting injuries, itching and allergies) and damage (loss of blood) to the affected animals. Fleas can also transmit various species of tapeworms. They therefore also pose a medical problem for the infected animals and also for the animal keepers. The animal keeper can also be attacked by fleas. In some humans, this causes flea sting allergy. An effective control of fleas in dogs and cats has therefore always been desirable and necessary, in particular since the number of these pets is increasing and they live in ever closer contact with humans.

A large number of insectidically active compounds for controlling fleas have become known to date. Such active compounds are, for example, from the class of the carbamates (propoxur, bendiocarb, carbaryl), from the class of the phosphoric esters (fenthione, diazinone) and from the class of the pyrethroids (permethrin, cypermethrin, resmerthrin).

These active compounds are dermally administered contact insecticides which act predominantly on adult fleas.

For the protection of pets against both problems, two separate treatments (parenteral or oral treatment against endoparasites, dermal treatment against ectoparasites) have been customary hitherto. It was desirable to replace these two treatments by one single treatment.

Combination products, usually for widening the spectrum of activity in the use against endoparasites, are already known.

Hitherto, a combined administration of endoparasiticides and ectoparasiticides has not been customary in practice.

The present invention provides compositions comprising at least one avermectin, 22,23-dihydroavermectin B₁ (ivermectins) or milbemycin from the class of the macrocyclic lactones with agonists or antagonists of the nicotinergic acetylcholine receptors of insects.

Surprisingly, these active compounds which originate from entirely different chemical classes and which have entirely different biological activities influence each other synergistically.

The use of avermectins, 22,23-dihydroavermectins B₁ (ivermectins) and milbemycins from the class of the macrocyclic lactones as endoparasiticides has been known for a long time and is the subject of numerous patent applications and review articles (for example biological effects in: Ivermectin and Abamectin, W. C. Campbell, Ed., Springer Verlag, New York, N.Y., 1989; Avermectins and Milbemycins Part II, H. G. Davies et al., Chem. Soc. Rev. 20 (1991) p. 271-339; Chemical Modifications in: G. Lukacs et al. (Eds.), Springer-Verlag, N.Y., (1990), Chapter 3; Cydectin™ [moxidectin and derivatives]: G. T. Carter et al., J. Chem. Soc. Chem. Commun. (1987), p. 402-404); EP 423 445-Al). The use of doramectin (Pfizer) as an endoparasiticide is also known (cf. “Doramectin—a potent novel endectozide” A. C. Goudie et al., Vet. Parasitol. 49 (1993), p. 5-15).

Furthermore, combinations of avermectins, 22,23-dihydroavermectins B₁ (ivermectins) or milbemycins with certain classes of anthelmintics such as, for example, benzimidazoles, salicylamides, levamisole, pyrantel or praziquantel are the subject of numerous patent applications (for example: GB 2 252 730; GB 2 224 933; GB 2 21 3 722; EP-A 59 074).

Examples of avermectins and derivatives thereof include mixtures of macrolide lactones of the general formula (I)

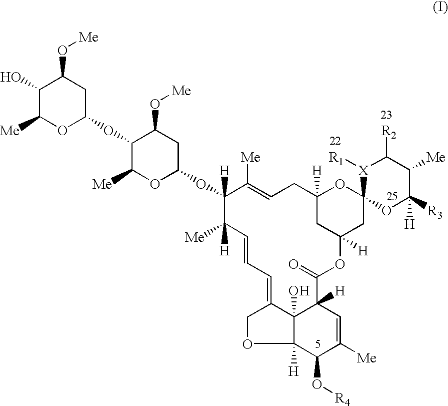

in which

the radicals R¹ to R⁴ are each as defined in Table 1 below and X can represent a single or double bond between the C₂₂ and C₂₃ position (—C₂₂R¹—X—C₂₃R²—)

In the case of a double bond there are no substituents (R¹, R²—) at the C₂₂ and C₂₃ position.

TABLE 1

| Macrocyclic lactone | —C₂₂R¹—X—C₂₃R²— | R³ | R⁴ |
|---|---|---|---|
| Avermectin A₁ₐ | —CH═CH— | -sec-Bu | —Me |
| Avermectin A_{1b} | —CH═CH— | -iso-Pr | —Me |
| Avermectin A₂ₐ | —CH₂—CHOH— | -sec-Bu | —Me |
| Avermectin A_{2b} | —CH₂—CHOH— | -iso-Pr | —Me |
| Avermectin B₁ₐ | —CH═CH— | -sec-Bu | —H |
| Avermectin B_{1b} | —CH═CH— | -iso-Pr | —H |
| Avermectin B₂ₐ | —CH₂—CHOH— | -sec-Bu | —H |
| Avermectin B_{2b} | —CH₂—CHOH— | -iso-Pr | —H |
| 22,23-Dihydroavermectin B₁ₐ | —CH₂—CH₂— | -sec-Bu | —H |
| 22,23-Dihydroavermectin B_{1b} | —CH₂—CH₂— | -iso-Pr | —H |
| Doramectin | —CH═CH— | -Chx | —H |

22,23-Dihydroavermectin B₁ represents ivermectin B₁;
sec-Bu = secondary butyl; iso-Pr = isopropyl; Chx = cyclohexyl; —Me = methyl

The avermectins and 22,23-dihydroavermectins B₁ (ivermectins) of the general formula (I) are generally employed as mixtures. Of particular interest in this context is the product abamectin, which essentially comprises the avermectins B₁ and hydrogenation products thereof, the 22,23-dihydroavermectins B₁ (ivermectin).

The compounds labelled “b” among the macrocyclic lactones, which possess an iso-propyl radical in the C₂₅ position, need not necessarily be separated from the “a” compounds, which have a sec-butyl group in the C₂₅ position. Generally, the mixture of both substances is isolated, consisting of >80% sec-butyl derivative (B₁ₐ) and <20% iso-propyl derivative (B_{1b}), and can be used in accordance with the invention. Moreover, in the case of the stereoisomers, the substituents in the C₁₃ and C₂₃ position can be arranged in both α and β configuration on the ring system, i.e. they can be located above or below the plane of the molecule.

The milbemycins have the same macrolide ring structure as the avermectins or 22,23-dihydroavermectins B₁ (ivermectins), but carry no substituent (i.e. missing oleandrose disaccharide fragment) in position 13 (R⁵=hydrogen).

Examples of milbemycins of the class of the macrocyclic lactones include the compounds of the general formula (II)

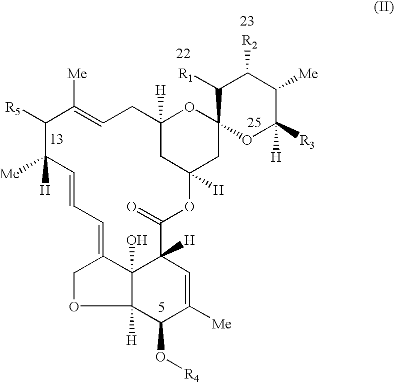

in which

radicals R¹ to R¹ are each as defined in Table 2 below:

TABLE 2

| Macrocyclic | | | | | |
|---|---|---|---|---|---|
| lactone | R¹ | R² | R³ | R⁴ | R⁵ |
| Milbemycin | —H | —H | -iso-Pr | —H | —H |
| B41 D | | | | | |
| Nemadectin | —H | —OH | 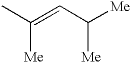 | —H | —H |
| Moxidectin | —H | ═N—O—Me | 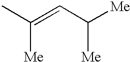 | —H | —H |

iso-Pr = isopropyl

Particularly suitable co-components for the mixtures according to the invention are:

Avermectin B₁ₐ/B_{1b};

22,23-Dihydroavermectin B₁ₐ/B_{1b} (or ivermectin B₁ₐ/B_{1b});

Doramectin;

Moxidectin.

Agonists or antagonists of the nicotinergic acetylcholine receptors of insects are known, for example from the European laid-open applications No. 464 830, 428 941, 425 978, 386 565, 383 091, 375 907, 364 844, 315 826, 259 738, 254 859, 235 725, 212 600, 192 060, 163 855, 154 178, 136 636, 303 570, 302 833, 306 696, 189 972, 455 000, 135 956, 471 372, 302 389; the German laid-open applications No. 3 639 877, 3 712 307; the Japanese laid-open applications No. 03 220 176, 02 207 083, 63 307 857, 63 287 764, 03 246 283, 04 9371, 03 279 359, 03 255 072; U.S. Pat. Nos. 5,034,524, 4,948,798, 4,918,086, 5,039,686, 5,034,404; PCT applications No. WO 91/17,659, 91/4965; the French application No. 2 611 114; the Brazilian application No. 88 03 621.

The formulae and definitions described in these publications and the individual preparations and compounds described therein are expressly incorporated herein by reference.

These compounds are preferably represented by the general formula (I)

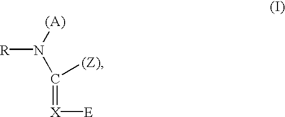

in which

R represents hydrogen, or represents optionally substituted radicals from the group consisting of acyl, alkyl, aryl, aralkyl, heteroaryl and heteroarylalkyl;

A represents a monofunctional group from the group consisting of hydrogen, acyl, alkyl and aryl or represents a bifunctional group linked to the radical Z;

E represents an electron-withdrawing radical;

X represents the radicals —CH═ or ═N— where the radical —CH═ may be linked to the radical Z instead of an H atom;

Z represents a monofunctional group from the group consisting of alkyl, —O—R, —S—R and

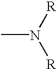

or represents a bifunctional group linked to the radical A or to the radical X.

Particular preference is given to compounds of the formula (I) in which the radicals are as defined below:

R represents hydrogen and represents optionally substituted radicals from the group consisting of acyl, alkyl, aryl, aralkyl, heteroaryl and heteroarylalkyl.

Suitable acyl radicals include formyl, alkylcarbonyl, arylcarbonyl, alkylsulfonyl, arylsulfonyl, (alkyl-)-(aryl-)-phosphoryl, each of which may in turn be substituted.

Suitable alkyl includes C₁₋₁₀-alkyl, in particular C₁₋₄-alkyl, specifically methyl, ethyl, i-propyl, sec.- or t-butyl, each of which may in turn be substituted.

Suitable aryl includes phenyl and naphthyl, in particular phenyl.

Suitable arylalkyl includes phenylmethyl and phenethyl.

Suitable heteroaryl includes heteroaryl having up to 10 ring atoms and N, O and S, in particular N, as hetero atoms. Specific examples are thienyl, furyl, thiazolyl, imidazolyl, pyridyl and benzothiazolyl.

Suitable heteroarylalkyl includes heteroarylmethyl, heteroarylethyl having up to 6 ring atoms and N, O and S, in particular N, as hetero atoms.

Examples of preferred substituents are:

alkyl preferably having from 1 to 4, in particular 1 or 2, carbon atoms, such as methyl, ethyl, n- and i-propyl and n-, i- and t-butyl; alkoxy preferably having 1 to 4, in particular 1 or 2, carbon atoms, such as methoxy, ethoxy, n-, and i-propyloxy and n-, i- and t-butyloxy; alkylthio preferably having 1 to 4, in particular 1 or 2, carbon atoms, such as methylthio, ethylthio, n- and i-propylthio and n-, i- and t-butylthio; halogenoalkyl preferably having 1 to 4, in particular 1 or 2, carbon atoms and preferably 1 to 5, in particular 1 to 3, halogen atoms, where the halogen atoms are identical or different and are preferably fluorine, chlorine or bromine, in particular fluorine, such as trifluoromethyl; hydroxyl; halogen, preferably fluorine, chlorine, bromine and iodine, in particular fluorine, chlorine and bromine; cyano; nitro; amino; monoalkyl- and dialkylamino preferably having 1 to 4, in particular 1 or 2, carbon atoms per alkyl group, such as methylamino, methyl-ethyl-amino, n- and i-propylamino and methyl-n-butylamino; carboxyl, carbalkoxy preferably having 2 to 4, in particular 2 or 3, carbon atoms, such as carbomethoxy and carboethoxy; sulfo (—SO₃H); alkylsulfonyl preferably having 1 to 4, in particular 1 or 2, carbon atoms, such as methylsulfonyl and ethylsulfonyl; arylsulfonyl preferably having 6 or 10 arylcarbon atoms, such as phenylsulfonyl, and heteroarylamino and heteroarylalkylamino, such as chloropyridylamino and chloropyridylmethylamino.

A particularly preferably represents hydrogen and represents optionally substituted radicals from the group consisting of acyl, alkyl and aryl, each of which are preferably as defined under R. Furthermore, A represents a bifunctional group. Suitable bifunctional groups include optionally substituted alkylene having 1-4, in particular 1-2, carbon atoms, suitable substituents being the substituents listed further above, it being possible for the alkylene groups to be interrupted by hetero atoms from the group consisting of N, O and S.

A and Z together with the atoms to which they are attached may form a saturated or unsaturated heterocyclic ring. The heterocyclic ring may contain 1 or 2 more identical or different hetero atoms and/or hetero groups. Preferred hetero atoms are oxygen, sulfur or nitrogen and preferred hetero groups are N-alkyl, the alkyl of the N-alkyl group preferably containing 1 to 4, in particular 1 or 2, carbon atoms. Suitable alkyl includes methyl, ethyl, n- and i-propyl and n-, i- and t-butyl. The heterocyclic ring contains 5 to 7, preferably 5 or 6, ring members.

Examples of the heterocyclic ring include pyrrolidine, piperidine, piperazine, hexamethyleneimine, hexahydro-1,3,5-triazine and morpholine, each of which is optionally substituted, preferably by methyl.

E represents an electron-withdrawing radical; particular preference is given to NO₂, CN and halogenoalkylcarbonyl such as 1,5-halogeno-C₁₋₄-carbonyl, in particular COCF₃.

X represents —CH═ or —N═

Z represents the optionally substituted radicals alkyl, —OR, —SR and —NRR, where R and the substituents are preferably as defined above.

Z may, in addition to the abovementioned ring, together with the atom to which it is attached and the radical

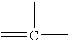

in the position of X form a saturated or unsaturated heterocyclic ring. The heterocyclic ring may contain 1 or 2 more identical or different hetero atoms and/or hetero groups. Preferred hetero atoms are oxygen, sulfur or nitrogen and preferred hetero groups are N-alkyl, the alkyl or N-alkyl group preferably containing 1 to 4, in particular 1 or 2, carbon atoms. Suitable alkyl includes methyl, ethyl, n- and i-propyl and n-, i- and t-butyl. The heterocyclic ring contains 5 to 7, preferably 5 or 6, ring members.

Examples of the heterocyclic ring include pyrrolidine, piperidine, piperazine, hexamethylenimine, morpholine and N-methylpiperazine.

Very particularly preferred compounds utilizable according to the invention are compounds of the general formulae (II) and (III):

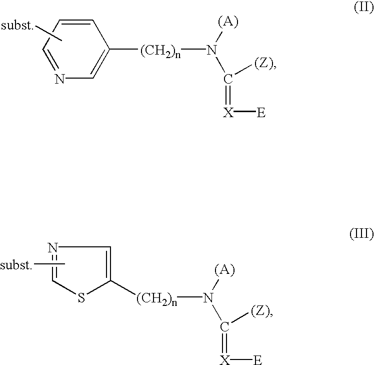

in which

n represents 1 or 2,

subst. represents one of the substituents listed above, in particular halogen, especially chlorine,

A, Z, X and E are as defined above.

Specific examples are the following compounds:

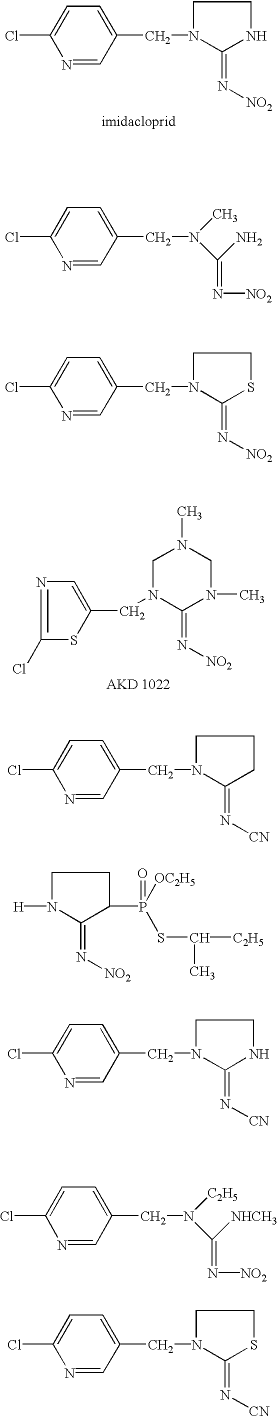

Very particular preference is given to the compounds imidacloprid, Ti 435 and AKD 1022.

For example, the 22,23-dihydroavermectins B₁ₐ/B_{1b} (ivermectins B₁ₐ/B_{1b}) of the general formula (Ia) from the class of the macrocyclic lactones

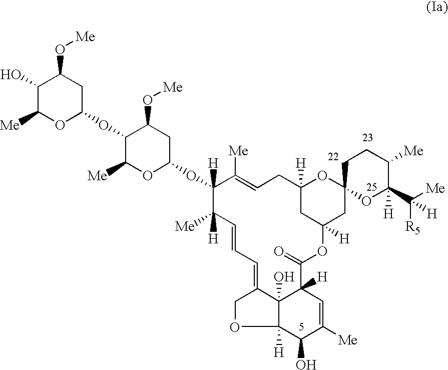

in which

R⁵ represents methyl and ethyl

are combined as co-components according to the invention with imidacloprid, if appropriate in the presence of other active compounds and carriers, in a synergistic ratio.

For example, the 22,23-dihydroavermectins B₁ₐ/B_{1b} (ivermectins B₁ₐ/B_{1b}) of the general formula (Ia) from the class of the macrocyclic lactones

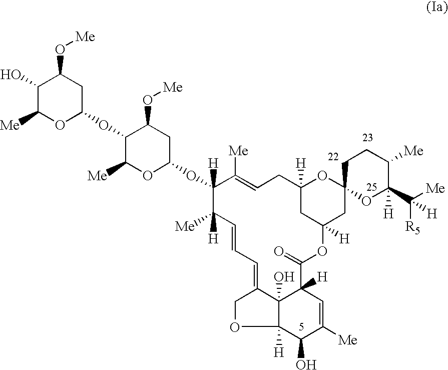

in which

R⁵ represents methyl and ethyl

are combined as co-components according to the invention with Ti 435, if appropriate in the presence of other active compounds and carriers, in a synergistic ratio.

The endoparasiticidal activity of the active compound combinations according to the invention is significantly higher than was to be expected from the activities of the individual components. Therefore, by employing these combinations, it is possible to reduce the application rate and the number of applications.

Having low toxicity to warm-blooded species, the compositions according to the invention are suitable for controlling pathogenic endoparasites and ectoparasites which occur in humans and in animal keeping and animal breeding, in productive animals, breeding animals, zoo animals, laboratory animals, animals for experimentation and pets. They are active against all or individual stages of development of the pests and against resistant and normally sensitive species. By controlling the pathogenic endoparasites the intention is to reduce disease, mortality and reductions in yield, so that the use of the active compounds enables more economical and simpler animal keeping. The pathogenic endoparasites include nematodes and Acantocephalea, in particular:

From the subclass of the Monogenea, e.g. Gyrodactylus spp., Dactylogyrus spp., Polystoma spp.

From the order of the Enoplida e.g.: Trichuris spp., Capillaria spp., Trichomosoides spp., Trichinella spp.

From the order of the Rhabditia e.g.: Micronema spp., Strongyloides spp.

From the order of the Strongylida e.g.: Stronylus spp., Triodontophorus spp., Oesophagodontus spp., Trichonema spp., Gyalocephalus spp., Cylindropharynx spp., Poteriostomum spp., Cyclococercus spp., Cylicostephanus spp., Oesophagostomum spp., Chabertia spp., Stephanurus spp., Ancylostoma spp., Uncinaria spp., Bunostomum spp., Globocephalus spp., Syngamus spp., Cyathostoma spp., Metastrongylus spp., Dictyocaulus spp., Muellerius spp., Protostrongylus spp., Neostrongylus spp., Cystocaulus spp., Pneumostrongylus spp., Spicocaulus spp., Elaphostrongylus spp., Parelaphostrongylus spp., Crenosoma spp., Paracrenosoma spp., Angiostrongylus spp., Aelurostrongylus spp., Filaroides spp., Parafilaroides spp., Trichostrongylus spp., Haemonchus spp., Ostertagia spp., Marshallagia spp., Cooperia spp., Nematodirus spp., Hyostrongylus spp., Obeliscoides spp., Amidostomum spp., Ollulanus spp.

From the order of the Oxyurida e.g.: Oxyuris spp., Enterobius spp., Passalurus spp., Syphacia spp., Aspiculuris spp., Heterakis spp.

From the order of the Ascaridia e.g.: Ascaris spp., Toxascaris spp., Toxocara spp., Parascaris spp., Anisakis spp., Ascaridia spp.

From the order of the Spirurida e.g.: Gnathostoma spp., Physaloptera spp., Thelazia spp., Gongylonema spp., Habronema spp., Parabronema spp., Draschia spp., Dracunculus spp.

From the order of the Filariida e.g.: Stephanofilaria spp., Parafilaria spp., Setaria spp., Loa spp., Dirofilaria spp., Litomosoides spp., Brugia spp., Wuchereria spp., Onchocerca spp.

From the order of Gigantorhynchida e.g.: Filicollis spp., Moniliformis spp., Macracanthorhynchus spp., Prosthenorchis spp.

The ectoparasites include:

from the order of the Anoplura, e.g.: Haematopinus spp., Linognathus spp., Solenopotes spp., Pediculus spp., Pthirus spp.;

from the order of the Mallophaga, e.g.: Trimenopon spp., Menopon spp., Ecomenacanthus spp., Menacanthus spp., Trichodectes spp., Felicola spp., Damalinea spp., Bovicola spp.;

from the order of the Diptera, e.g.: Chrysops spp., Tabanus spp., Musca spp., Hydrotaea spp., Muscina spp., Haematobosca spp., Haematobia spp., Stomoxys spp., Fannia spp., Glossina spp., Lucilia spp., Calliphora spp., Auchmeromyia spp., Cordylobia spp., Cochliomyia spp., Chrysomyia spp., Sarcophaga spp., Wohlfartia spp., Gasterophilus spp., Oesteromyia spp., Oedemagena spp., Hypoderma spp., Oestrus spp., Rhinoestrus spp., Melophagus spp., Hippobosca spp.

From the order of the Siphonaptera, e.g.: Ctenocephalides spp., Echidnophaga spp., Ceratophyllus spp.

Particular emphasis is given to the activity against Siphonaptera, in particular against fleas.

The productive and breeding animals include mammals such as cattle, horses, sheep, pigs, goats, camels, water buffalo, donkeys, rabbits, fallow deer and reindeer, fur-bearing animals such as mink, chinchilla and raccoon, birds such as hens, geese, turkeys and ducks, fresh- and salt-water fish such as trout, carp and eels.

Laboratory and experimental animals include mice, rats, guinea-pigs, golden hamsters, dogs and cats.

The pets include dogs and cats.

Administration can be carried out both prophylactically and therapeutically.

Administration of the active compounds is carried out directly or in the form of suitable preparations, orally or dermally. Dermal administration is particularly preferred.

Enteral administration of the active compounds is carried out, for example, orally in the form of powders, tablets, capsules, pastes, drinks, granules, orally administrable solutions, suspensions and emulsions, boluses, medicated feed or drinking water. Dermal administration is carried out, for example, in the form of spraying or pouring-on and spotting-on.

Suitable preparations are:

solutions such as oral solutions, concentrates for oral administration after dilution, solutions for use on the skin or in body cavities, pouring-on formulations, gels;

emulsions and suspensions for oral or dermal administration; semi-solid preparations;

formulations in which the active compound is processed in an ointment base or in an oil-in-water or water-in-oil emulsion base;

Solid preparations such as powders, premixes or concentrates, granules, pellets, tablets, boluses, capsules; aerosols and inhalants, active compound-containing shaped articles.

Solvents which may be mentioned are: physiologically tolerable solvents such as water, alcohols such as ethanol, butanol, benzyl alcohol, glycerol, propylene glycol, polyethylene glycols, N-methyl-pyrrolidone, 2-pyrrolidone, and mixtures thereof.

The active compounds can optionally also be dissolved in physiologically tolerable vegetable or synthetic oils which are suitable for injection.

Solubilizers which may be mentioned are: solvents which promote the dissolution of the active compound in the main solvent or prevent its precipitation. Examples are polyvinylpyrrolidone, polyvinyl alcohol, polyoxyethylated castor oil, polyoxyethylated sorbitan ester.

Preservatives are: benzyl alcohol, trichlorobutanol, p-hydroxybenzoic acid esters, n-butanol.

Oral solutions are administered directly. Concentrates are administered orally after prior dilution to the use concentration. Oral solutions and concentrates are prepared according to the state of the art, sterile procedures not being necessary.

Solutions for use on the skin are trickled on, spread on, rubbed in, sprinkled on or sprayed on.

It may be advantageous to add thickeners during preparation. Thickeners are: inorganic thickeners such as bentonites, colloidal silicic acid, aluminium monostearate, organic thickeners such as cellulose derivatives, polyvinyl alcohols and their copolymers, acrylates and methacrylates.

Gels are applied to or spread on the skin or introduced into body cavities. Gels are prepared by treating solutions which have been prepared as described in the case of the injection solutions with sufficient thickener that a clear material having an ointment-like consistency results. The thickeners employed are the thickeners given above.

Pour-on formulations are poured or sprayed onto limited areas of the skin, the active compound penetrating the skin and acting systemically.

Pour-on formulations are prepared by dissolving, suspending or emulsifying the active compound in suitable skin-compatible solvents or solvent mixtures. If appropriate, other auxiliaries such as colorants, bioabsorption-promoting substances, antioxidants, light stabilizers, adhesives are added.

Solvents which may be mentioned are: water, alkanols, glycols, polyethylene glycols, polypropylene glycols, glycerol, aromatic alcohols such as benzyl alcohol, phenylethanol, phenoxyethanol, esters such as ethyl acetate, butyl acetate, benzyl benzoate, ethers such as alkylene glycol alkyl ethers such as dipropylene glycol monomethyl ether, diethylene glycol mono-butyl ether, ketones such as acetone, methyl ethyl ketone, cyclic carbonates such as propylene carbonate, ethylene carbonate, aromatic and/or aliphatic hydrocarbons, vegetable or synthetic oils, DMF, dimethylacetamide, n-alkylpyrrolidones such as methylpyrrolidone, n-butylpyrrolidone or n-octylpyrrolidone, N-methylpyrrolidone, 2-pyrrolidone, 2,2-dimethyl-4-oxy-methylene-1,3-dioxolane and glycerol formal.

Colorants are all colorants permitted for use on animals and which can be dissolved or suspended.

Absorption-promoting substances are, for example, DMSO, spreading oils such as isopropyl myristate, dipropylene glycol pelargonate, silicone oils and copolymers thereof with polyethers, fatty acid esters, triglycerides, fatty alcohols.

Antioxidants are sulfites or metabisulfites such as potassium metabisulfite, ascorbic acid, butylhydroxytoluene, butylhydroxyanisole, tocopherol.

Light stabilizers are, for example, novantisolic acid.

Adhesives are, for example, cellulose derivatives, starch derivatives, polyacrylates, natural polymers such as alginates, gelatin.

Emulsions can be administered orally, dermally or as injections.

Emulsions are either of the water-in-oil type or of the oil-in-water type.

They are prepared by dissolving the active compound either in the hydrophobic or in the hydrophilic phase and homogenizing this with the solvent of the other phase with the aid of suitable emulsifiers and, if appropriate, other auxiliaries such as colorants, absorption-promoting substances, preservatives, antioxidants, light stabilizers, viscosity-enhancing substances.

Hydrophobic phases (oils) which may be mentioned are: liquid paraffins, silicone oils, natural vegetable oils such as sesame oil, almond oil, castor oil, synthetic triglycerides such as caprylic/capric biglyceride, triglyceride mixture with vegetable fatty acids of the chain length C₈₋₁₂ or other specially selected natural fatty acids, partial glyceride mixtures of saturated or unsaturated fatty acids possibly also containing hydroxyl groups, mono- and diglycerides of the C₈/C₁₀ fatty acids.

Fatty acid esters such as ethyl stearate, di-n-butyryl adipate, hexyl laurate, dipropylene glycol perlargonate, esters of a branched fatty acid of medium chain length with saturated fatty alcohols of chain length C₁₆-C₁₈, isopropyl myristate, isopropyl palmitate, caprylic/capric acid esters of saturated fatty alcohols of chain length C₁₂-C₁₈, isopropyl stearate, oleyl oleate, decyl oleate, ethyl oleate, ethyl lactate, waxy fatty acid esters such as synthetic duck coccygeal gland fat, dibutyl phthalate, diisopropyl adipate, ester mixtures related to the latter, inter alia.

Fatty alcohols such as isotridecyl alcohol, 2-octyldodecanol, cetylstearyl alcohol, oleyl alcohol.

Fatty acids such as oleic acid and its mixtures.

Hydrophilic phases which may be mentioned are:

water, alcohols such as propylene glycol, glycerol, sorbitol and its mixtures.

Emulsifiers which may be mentioned are: non-ionic surfactants, e.g. polyethoxylated castor oil, polyethoxylated sorbitan monooleate, sorbitan monostearate, glycerol monostearate, polyoxyethyl stearate, alkylphenol polyglycol ether;

ampholytic surfactants such as di-Na N-lauryl-β-iminodipropionate or lecithin;

anionic surfactants, such as Na lauryl sulfate, fatty alcohol ether sulfates, mono/dialkyl polyglycol ether orthophosphoric acid ester monoethanolamine salt;

cation-active surfactants, such as cetyltrimethylammonium chloride.

Further auxiliaries which may be mentioned are: substances which enhance the viscosity and stabilize the emulsion, such as carboxymethylcellulose, methylcellulose and other cellulose and starch derivatives, polyacrylates, alginates, gelatin, gum arabic, polyvinylpyrrolidone, polyvinyl alcohol, copolymers of methyl vinyl ether and maleic anhydride, polyethylene glycols, waxes, colloidal silicic acid or mixtures of the substances mentioned.

Suspensions can be administered orally or dermally. They are prepared by suspending the active compound in a suspending agent, if appropriate with addition of other auxiliaries such as wetting agents, colorants, bioabsorption-promoting substances, preservatives, antioxidants, light stabilizers.

Liquid excipients which may be mentioned are all homogeneous solvents and solvent mixtures.

Wetting agents (dispersants) which may be mentioned are the surfactants given above.

Other auxiliaries which may be mentioned are those given above.

Semi-solid preparations can be administered orally or dermally. They differ from the suspensions and emulsions described above only by their higher viscosity.

For the production of solid preparations, the active compound is mixed with suitable excipients, if appropriate with addition of auxiliaries, and brought into the desired form.

Excipients which may be mentioned are all physiologically tolerable solid inert substances. Those used are inorganic and organic substances. Inorganic substances are, for example, sodium chloride, carbonates such as calcium carbonate, hydrogencarbonates, aluminium oxides, titanium oxide, silicic acids, argillaceous earths, precipitated or colloidal silica, phosphates.

Organic substances are, for example, sugar, cellulose, foodstuffs and feeds such as milk powder, animal meal, grain meals and shreds, starches.

Auxiliaries are preservatives, antioxidants, colorants which have already been mentioned above.

Other suitable auxiliaries are lubricants and glidants such as magnesium stearate, stearic acid, talc, bentonites, disintegration-promoting substances such as starch or crosslinked polyvinylpyrrolidone, binders such as starch, gelatin or linear polyvinylpyrrolidone, and dry binders such as microcrystalline cellulose.

The active compounds can also be present in the preparations as a mixture with synergists or with other active compounds which act against pathogenic endoparasites. Such active compounds are, for example, L-2,3,5,6-tetrahydro-6-phenylimidazothiazole, benzimidazole carbamates, pyrantel, praziquantel, epsiprantel.

Ready-to-use preparations contain the compounds acting against ectoparasites in concentrations of 10 ppm—20 per cent by weight, preferably from 0.1-12.5 per cent by weight.

Preparations which are diluted before use contain the compounds acting against ectoparasites in concentrations of 0.5-90% by weight, preferably of 5-50% by weight.

Furthermore, the preparations comprise the above-described active compounds against endoparasites in concentrations of 10 ppm—2% by weight, preferably of 0.05-0.9% by weight, very particularly preferably of 0.005-0.25% by weight.

When used in the pet dog, the weight ratio of macrocyclic lactone to agonist or antagonist of the nicotinergic acetylcholine receptors of insects in the compositions according to the invention is generally 1:500 to 1000, preferably 1:500 to 850 and very particularly preferably 1:500.

Finally, when used in useful animals, the weight ratio of macrocyclic lactone to agonist or antagonist of the nicotinergic acetylcholine receptors of insects in the compositions according to the invention is generally 1:20 to 400, preferably 1:20 to 250 and very particularly preferably 1:20 to 50.

In the examples below, the agonist or antagonist of the nicotinergic acetylcholine receptors of insects is 1-[(6-chloro-3-pyridinyl)methyl]-N-nitro-2-imidazolidinium (common name imidacloprid) and the macrocyclic lactone is ivermectin.

### EXAMPLES

### Example 1

SL formulation (water-soluble concentrate)

| | | |
|---|---|---|
| 18.3 | g | of imidacloprid |
| 0.2 | g | of ivermectin |
| 2.5 | g | of a neutral emulsifier based on alkylaryl polyglycol ether |
| 3.5 | g | of diisooctyl sulfosuccinate, sodium salt |
| 38.4 | g | of dimethyl sulfoxide and |
| 37.5 | g | of 2-propanol |

### Example 2

Pour-on formulation

| | | |
|---|---|---|
| 20.3 | g | of imidacloprid |
| 0.2 | g | of ivermectin |
| 1.8 | g | of polyvinyl alcohol |
| 1.8 | g | of a block copolymer based on ethylene oxide and |
| | | propylene oxide |
| 0.26 | g | of xanthan gum |
| 9.0 | g | of glycerol |
| 59.2 | g | of distilled water |

### Example 3

Spot-on formulation

| | | |
|---|---|---|
| 10.000 | g | of imidacloprid |
| 0.006 | g | of ivermectin |
| 83.394 | g | of benzyl alcohol |
| 16.300 | g | of propylene carbonate |
| 0.100 | g | of BHT (butylated hydroxytoluene) |

### Example 4

Spot-on formulation

| | | |
|---|---|---|
| 10.000 | g | of imidacloprid |
| 0.050 | g | of ivermectin |
| 83.350 | g | of benzyl alcohol |
| 16.300 | g | of propylene carbonate |
| 0.100 | g | of BHT |

### Example 5

Spot-on formulation:

| | | |
|---|---|---|
| 10.000 | g | of imidacloprid |
| 0.200 | g | of ivermectin |
| 83.200 | g | of benzyl alcohol |
| 16.300 | g | of propylene carbonate |
| 0.100 | g | of BHT |

### Use Example A

1 ml of the SL formulation of Example 1 was applied as a solution by pouring onto the shoulder of a dog infested with 200 fleas. The test animal was immediately free of adult fleas. The treatment according to the invention leads to a flea mortality rate of 100%.

### Use Example B

1 ml of the formulation of Example 1 was diluted in 1 l of water and this solution was poured over dogs of about 20 kg weight infested with fleas until they were dripping wet. The following results were obtained:

TABLE B

| | Number of fleas | | |
|---|---|---|---|
| Period of time | per dog | | |
| Day | Untreated | Treated | % activity |
| −1 Infestation with 100 fleas | | | |
| 0 Treatment and count | 30 | 0 | 100 |
| 5, 8 Infestation with 100 fleas | | | |
| 9 Count | 56 | 0 | 100 |
| 15 Infestation with 100 fleas | | | |
| 16 Count | 76 | 0 | 100 |
| 19 Infestation with 100 fleas | | | |
| (untreated animals) | | | |
| 250 fleas (treated animals) | | | |
| 20 Count | 39 | 0 | 100 |
| 26 Infestation with 100 fleas | | | |
| 27 Count | 43 | 0 | 100 |

### Use Example C

In vivo Nematode Test

Nematospiroides dubius in Mice

Mice were experimentally infected with nematodes of the species Nematospiroides dubius. Specifically, the mice were administered Nematospiroides dubius orally as 60 filariform larvae.

After the prepatency period had expired, the suspended active compounds of Example 2 were administered orally on day 12 after the infection.

Determination of the activity:

The mice are selected on day 20 after the infection. The adult parasites in the Duodenum are counted by means of a compressorium. The success of treatment in the dose group is compared to the untreated control group.

Tables A and B below indicate the action of the combination against Nematospiroides dubius in mice.

TABLE C
Action of the combination of imidacloprid and ivermectin B₁ₐ/B_{1b}
against Nematospiroides dubius in mice after oral administration

| | |
|---|---|
| Active compound and amount | Reduction rate |
| [mg/kg] | [%] |

| | | |
|---|---|---|
| Imidacloprid | 50.0 | 0 |
| Ivermectin B₁ₐ/B_{1b} | 0.1 | 0 |
| Ivermectin B₁ₐ/B_{1b} + | 50.0 | 100 |
| imidacloprid | 0.1 | |
| Imidacloprid | 25.0 | 0 |
| Imidacloprid + | 25.0 | >80 |
| ivermectin b₁ₐ/B_{1b} | 0.1 | |

### Example D

In vivo Nematode Test

Heterakis spumosa in Mice

Mice were experimentally infected with nematodes of the species Heterakis spumosa. Specifically, the mice were administered Heterakis spumosa orally as 90 embryonate eggs.

After the prepatency period had expired, the suspended active compounds of Example 2 were administered orally on day 46 after the infection.

Determination of the activity:

The mice are selected on day 54 after the infection. The adult parasites are counted in the colon and caecum using a microscope. The success of treatment in the dose group is compared to the untreated control group.

The table below indicates the action of the combination against Heterakis spumosa in mice.

TABLE D
Action of the combination of imidacloprid and ivermectin B₁ₐ/B_{1b}
against Heterakis spumosa in mice after oral administration

| | |
|---|---|
| Active compound and amount | Reduction rate |
| [mg/kg] | [%] |

| | | |
|---|---|---|
| Imidacloprid | 50.0 | 0 |
| Ivermectin B₁ₐ/B_{1b} | 0.1 | <50 |
| Imidacloprid + | 50.0 | 100 |
| ivermectin B₁ₐ/B_{1b} | 0.1 | |
| Imidacloprid | 25.0 | 0 |
| Imidacloprid + | 25.0 | 100 |
| ivermectin B₁ₐ/B_{1b} | 0.1 | |
| Imidacloprid | 10.0 | 0 |
| Imidacloprid + | 10.0 | >80 |
| ivermectin B₁ₐ/B_{1b} | 0.1 | |
| Imidacloprid | 5.0 | 0 |
| Imidacloprid + | 5.0 | >80 |
| ivermectin B₁ₐ/B_{1b} | 0.1 | |

### Use Example E

The insecticidal and nematocidal activity of three imidacloprid/ivermectin formulations was compared in four groups of test dogs using constant application volumina of 0.1 ml/kg. The test substances were administered by spot-on. The percentage ivermectin in the formulations was accordingly 0.006%, 0.05% and 0.2%. Each of the test substances comprised a constant percentage of 10% imidacloprid. All animals of the respective treatment and control groups were clinically examined for flea and nematode infestation at defined intervals before and after the treatment.

| | |
|---|---|
| Test period: | 4 weeks |
| Test substances: | |
| I. Imidacloprid | |
| Content of a.i.: | 10% w/v |
| II. Ivermectin | |
| Content of a.i.: | 0.006% w/v (Example E1) |
| | 0.05% w/v (Example E2) |
| | 0.2% w/v (Example E3) |
| Test animals | |
| Species: | dog (Canis familiaris) |
| Breed: | Beagle |
| Number: | 8 |
| Sex: | 4 female and 4 male animals |
| Age: | puppies: 2-3 months old |

Experimental Infestation with Fleas

Each dog was infested in the region of the inner thigh fold with about 100 fleas, which were up to four weeks old, on day-3 before the treatment. Reinfestations were carried out every week.

Experimental Infestation With Nematodes

20 days before the treatment, each dog was infected with 250 infectious larvae (1,3) of Acylostoma caninum.

Administration

The animals were treated once using the spot-on method. A treatment group was in each case formed by two animals. The adminstration volume was 0.1 ml/kg for all animals.

Clinical Examination of the Activity

For the assessment of the insecticidal effect of the treatment, all dogs were quantitatively examined for flea infestation prior to the treatment and then in each case 24 hours after treatment or after each flea reinfestation. The endoparasiticidal activity was determined by counting the worms that were excreted with the faeces before and after the treatment (day 1-3 after treatment).

Results

In all test groups, an insecticidal activity of 100% was detected over a period of 28 days. The endoparasiticidal activity depends on the dose, see the table below.

| Formulation | |
|---|---|
| (% Imidacloprid/% Ivermectin | Activity |
| 10/0.006 | 60% |
| 10/0.05 | 95% |
| 10/0.2 | 99% |

1. Endo-/ectoparasiticidal compositions comprising at least avermectin, 22,23-dihydroavermectin B₁, (ivermectin) or milbemycin from the class of the macrocyclic lactones with agonists or antagonists of the nicotinergic acetylcholine receptors of insects, if appropriate in the presence of other active compounds and diluents or excipients.
